(19) United States
(12) Patent Application Publication
(10) Pub. No.: US 2018/0067292 A1
(43) Pub. Date: Mar. 8, 2018

(54) RADIATION CONCENTRATOR INCORPORATING COMPOUND CONFOCAL UNEVEN PARABOLIC PRIMARY REFLECTOR, TAILORED SECONDARY REFLECTOR AND TAILORED RECEIVER

(71) Applicant: Nevin NOBLE, Chochin (IN)

(72) Inventor: Nevin NOBLE, Chochin (IN)

(21) Appl. No.: 15/810,031

(22) Filed: Nov. 11, 2017

Related U.S. Application Data
(63) Continuation-in-part of application No. PCT/IB2015/058617, filed on Nov. 8, 2015.
Application No. PCT/IB2015/058617 is a continuation-in-part of application No. PCT/IB2017/053540, filed on Jun. 14, 2017.

(30) Foreign Application Priority Data
May 15, 2015 (IN) 2472/CHE/2015
Jun. 16, 2016 (IN) 201643020587

(51) Int. Cl. G02B 19/00

(52) U.S. Cl. CPC G02B 19/0023; G02B 19/0028; G02B 19/0042

(57) ABSTRACT

A radiation concentrator incorporating a main radiation concentrator (160) and an auxiliary radiation concentrator (161) that concentrates the incident radiation to the common receiver (3) is presented. The primary reflector (1) of the main concentrator (160) consists of two confocal parabolic reflectors (5a & 5b) on either side of the axial plane in such a way that their parabolic axes points at the centers of the diagonally opposite halves of the radiation source. The main concentrator (160) is configured in such a way that a part of the radiation reflected from every point on its primary reflector (1) is absorbed by the receiver (3) directly and its secondary reflector (2) reflects the other part of the radiation to the receiver (3). The auxiliary concentrator (161) concentrates a substantial part of the incident radiation, which would have been blocked by the secondary reflector (2), to the receiver (3).

### FIELD OF INVENTION

This invention relates to radiation concentrators that employ parabolic reflectors which may be used as solar collectors, to collect solar energy in the form of thermal energy which in turn may be converted to electric energy as its receiver attains high temperature. The radiation concentrators may be a dish type (3D) concentrator or a trough type (2D) concentrator.

### PRIOR ART

The efficiency of a solar collector depends upon the concentration achieved by it. The efficiency increases, as the concentration achieved increases. The ideal concentration (theoretically achievable maximum) for a 3-D concentrator is 1/sin²θ and for a 2-D concentrator it is 1/sin θ; where θ is half the angle subtended by the radiation source (2θ).

The solar collectors according to the prior art include imaging concentrators like parabolic reflectors and non-imaging concentrators like compound parabolic concentrators (CPC), compound elliptical concentrators (CEC) etc. The non-imaging concentrator, CPC gives ideal concentration when employed as a trough type (2-D) concentrator. But for concentrating radiation from very far away sources like the sun, the CPC will have to be impractically tall; and hence cannot be use as an ideal solar collector. Imaging concentrators, such as parabolic reflectors are much more compact but they cannot achieve high concentrations that non-imaging concentrators can deliver.

For an imaging concentrator employing parabolic reflector, the receiver may be a flat receiver or an Omni-directional receiver (a conventional Omni-directional receiver has a circular cross section). For a trough type solar collector with a flat receiver, the maximum concentration achieved is 50% of the ideal concentration; when the rim-angle of the parabolic reflector is 45°. For a trough type solar collector with an Omni-directional receiver, the maximum concentration achieved is about 32% of the ideal concentration; when the rim-angle of the parabolic reflector is 90°.

One way to increase the concentration of a parabolic reflector with a flat receiver, according to the prior art, is to combine the parabolic reflector with a non-imaging concentrator, like CPC or CEC, as primary and secondary reflectors/concentrators respectively. CPC is a special case of CEC and CEC is more suitable to be used as secondary concentrator. The combination of parabolic primary with CEC secondary reflector gives a maximum concentration, for 2θ=0.52°, of approximately 96% of the ideal concentration, for rim angle approximately 9°. A parabolic reflector of rim angle approximately 9° has its focus at a very large distance which makes it an impractical design. A more practical design of the combination of parabolic primary with CEC secondary reflector has a parabolic reflector of rim angle approximately 45° and 40° which gives an approximate combined concentration of 70% and 75%. A parabolic reflector of rim angle approximately 45° and 40° will have its focus, and thereby the receiver, away from the aperture; which makes the design difficult to track the sun.

In the combination of parabolic primary with non-imaging concentrator secondary, the surface of the secondary reflectors has to touch the receiver, it causes the loss of heat from the receiver; also much heat is radiated from the other side of the flat receiver tube or plate. Reflectors which are made of glass will not be able to withstand the thermal shock and breaks. There are some designs with insulators between receiver and the secondary reflectors and around the flat tubular receivers. This makes the shape of the secondary reflector imperfect and prevents a part of the incoming radiation from reaching the receiver surface. And as no insulator is a perfect insulator some heat will still be lost by conduction. Also heating on one side can cause the receiver to bend.

For a parabolic reflector with an Omni-directional receiver, one way to increase the concentration according to the prior art, is to reshape the receiver to better fit all the edge rays reflected by the parabolic reflector. This receiver captures all the rays reflected off the parabolic reflector and is smaller than what a conventional circular receiver would need to be to do the same. Yet the concentration achieved is much lower than the ideal concentration.

The combination of parabolic primary with secondary concentrators having multiple entry apertures is another way to increase the concentration of a parabolic reflector with an Omni-directional receiver. In this combination, the primary and secondary concentrators are divided into sections. Each section of the secondary concentrator collects light from corresponding section of the primary concentrator. This kind of device has been proposed with a large number of divisions for primary and secondary concentrators. Though this kind of device can have the primary reflectors of rim angle up to 90°, the secondary concentrator becomes complex and difficult to manufacture. The secondary reflectors have to touch the receiver surface which makes it impossible to use a secondary reflector having the perfect shape for this device. Also the light rays passing through the secondary undergo multiple reflections and thereby reducing the energy of the light beam.

There are combinations of parabolic reflector primary with various Tailored Edge Ray Concentrator secondary reflectors with an Omni-directional receiver, according to the prior art. This method enables us to design simple secondary optics that attains high concentrations at large primary rim angles. For example, for a rim angle of 90°, an acceptance angle (2θ) of 0.007 rad (0.4°) and a concentration of 70% of the ideal maximum. The shading of the primary by the secondary is about 2%. All the light reflected by the primary reaches the secondary. However, in this method also, the secondary reflectors have to touch the receiver surface and the light rays undergo multiple reflections by the secondary reflector.

### Brief Description of the Invention Disclosed in the Main Application

The invention incorporates a primary reflector consisting of two uneven confocal parabolic reflectors on either side of the axial plane of the system; where axes of both the uneven parabolic reflectors are directed to the centers of diagonally opposite halves of the radiation source. As the uneven parabolic reflectors focus the radiation from their diagonally opposite half of the source to their common focus, a receiver placed at the common focus absorbs a half of these rays directly. The receiver in this invention is shaped to fit in the envelope, formed by the upper edge rays and the middle rays (the middle rays are those rays which pass through the angular bisectors of the angles formed between the upper and lower edge rays reflected from the primary reflector) from both halves of the radiation source. Such a receiver absorbs the upper half of radiation reflected from all points of the primary reflector. The secondary reflector employed in this invention has an upper and a lower surface. Upper surface is shaped along the normals to the reflected middle rays from both the uneven parabolic reflectors and the lower surface is shaped along circular arcs with their centers at the lower edge of the receiver. Such a secondary reflector reflects the lower half of radiation reflected from all points of the primary reflector to the receiver. But the secondary reflector blocks some radiation from reaching the primary reflector; as a result the effective concentration achieved by the concentrator is reduced

### OBJECTS OF THE INVENTION

An object of the invention is to device a main radiation concentrator, which can be paired with an auxiliary concentrator, incorporating parabolic primary reflectors that give good concentration ratio, for small acceptance angle, at rim-angles near 90°; so that the receiver of the system is very close to the aperture. Another object of the invention is to design a radiation concentrator, which achieves high concentration of radiation; with minimum energy loss due to multiple reflections. Yet another object of the invention is to design a radiation concentrator, which incorporates a secondary reflector that is not in contact with the receiver and is simple and easy to manufacture. Yet another object of the invention is to design an auxiliary radiation concentrator that can be paired with the main radiation concentrator in order to concentrate the light that would have been blocked by the secondary reflector of the main concentrator to the common receiver. Yet another object of the invention is to design a system of radiation concentrator, which incorporates a receiver that has a minimum surface area and absorbs all the radiation that enters the aperture of the system; that would be concentrated by the main and the auxiliary concentrators of the system.

### SUMMARY OF THE INVENTION

The invention incorporates a main radiation concentrator that concentrates most of the radiation to a common receiver and an auxiliary radiation concentrator that concentrates the radiation that would have been blocked by the secondary reflector of the first concentrator to the common receiver. The primary reflector of the first concentrator consisting of two confocal parabolic reflectors on either side of the axial plane of the system; where axes of both the parabolic reflectors are directed to the centers of diagonally opposite halves of the radiation source. As the parabolic reflectors focus the radiation from their diagonally opposite half of the source to their common focus, a receiver placed at the common focus absorbs a half of these rays directly. The receiver in this invention is shaped to fit in the caustic curves formed by the upper edge rays and the middle rays (the middle rays are those rays which pass through the angular bisectors of the angles formed between the upper and lower edge rays reflected from the primary reflector) from both halves of the radiation source. Such a receiver has a surface area much smaller than the surface area of the re-shaped receivers in the systems according the prior art and absorbs the upper half of radiation reflected from all points of the primary reflector. The secondary reflector employed in the first concentrator has an upper and a lower surface. Upper surface is shaped along the normals to the reflected middle rays from both the parabolic reflectors and the lower surface is shaped along circular arcs with their centers at the lower edge of the receiver. Such a secondary reflector reflects the lower half of radiation reflected from all points of the primary reflector to the receiver. Also, this secondary reflector does not touch the surface of the receiver. Also the secondary reflector has a gap directly above the receiver which allows an auxiliary concentrator to be paired with it, in such a way that the auxiliary concentrator concentrates and directs the radiation, which would have been blocked by the secondary reflector of the main concentrator, through the gap to the receiver. The second concentrator may be a combination of reflectors facing each other or a lens or any combination of reflective or/and refractive elements that concentrates radiation to a point after the concentrator along the line through which the radiation travels.

It is also possible to construct a primary-secondary combination of first concentrator where the rim angles of the primary parabolic reflectors are near 90°. In such a construction, the receiver will be very close to the aperture. As this design of radiation concentration system gives good concentration for small acceptance angle and as being an uncomplicated design, it can be easily implemented in a trough or dish type solar collector system.

### BRIEF DESCRIPTION OF DRAWINGS

Some exemplary embodiments of the present invention is illustrated by way of example in the accompanying drawings in which like reference numbers indicate the same or similar elements and in which:

FIG. 1a is a diagrammatic representation of the cross section of an exemplary embodiment of the present invention, that uses a lens as its auxiliary concentrator, for a distant source that subtends an angle 2.5°;

FIG. 1b is a diagrammatic representation of the cross section of an exemplary embodiment of the present invention, that uses a combination of mirrors as its auxiliary concentrator, for a distant source that subtends an angle 2.5°;

FIG. 2 is a diagrammatic representation of the cross section of the primary reflector of an exemplary embodiment illustrating its geometry;

FIG. 3 is a diagrammatic representation of the cross section of the primary reflector of an exemplary embodiment illustrating the trajectory of light reflected from it;

FIG. 4 is a diagrammatic illustration explaining the method of construction of an approximation of the left caustic curve formed by the upper rays and the middle rays;

FIG. 5 is a diagrammatic representation of the cross section of an exemplary embodiment illustrating the position of lower edges and different sections of the secondary reflector;

FIG. 6 is a diagrammatic representation illustrating the change in the caustic curves as a result of the shading of the primary reflector by the secondary reflector;

FIG. 7a is a diagrammatic representation of the cross section of the receiver of an exemplary embodiment, that does not use the auxiliary concentrator, illustrating its geometry;

FIG. 7b is a diagrammatic representation of the cross section of the receiver of an exemplary embodiment, that uses the auxiliary concentrator, illustrating its geometry;

FIG. 8 is a diagrammatic representation of the cross section of the lower section of the secondary reflector of an exemplary embodiment, illustrating its geometry;

FIG. 9 is a diagrammatic representation of the cross section of an exemplary embodiment illustrating the trajectory of light reflected from the lower section of the secondary reflector;

FIG. 10a is a diagrammatic representation of the cross section of an exemplary embodiment, that does not use the auxiliary concentrator, illustrating the orthogonal trajectories through which the cross section of the upper section of the secondary reflector is constructed;

FIG. 10b is a diagrammatic representation of the cross section of an exemplary embodiment, that uses the auxiliary concentrator, illustrating the orthogonal trajectories through which the cross section of the upper section of the secondary reflector is constructed;

FIG. 11 is a diagrammatic illustration explaining the method of construction of an approximation of the left orthogonal trajectory;

FIG. 12a is a diagrammatic representation of the cross section of an exemplary embodiment, that does not use the auxiliary concentrator, illustrating the position of the upper edge of the secondary reflectors;

FIG. 12b is a diagrammatic representation of the cross section of an exemplary embodiment, that uses the auxiliary concentrator, illustrating the position of the upper edge of the secondary reflectors;

FIG. 13 is a diagrammatic representation of the cross section of an exemplary embodiment illustrating the trajectory of light reflected from the upper section of the secondary reflector;

FIG. 14 is a diagrammatic representation of the cross section of an exemplary embodiment illustrating the trajectory of light through a lens, functioning as the auxiliary concentrator, paired with the main concentrator;

### DETAILED DESCRIPTION OF AN EXEMPLARY EMBODIMENT OF THE INVENTION

To clearly illustrate the features, geometry and principles of the invention the cross sectional view of various exemplary embodiments of the invention and the trajectory of light through them are described in the following part. The various embodiments described are trough type radiation concentrators, suitable for different distant radiation sources which subtends different angles at the aperture of the concentrator.

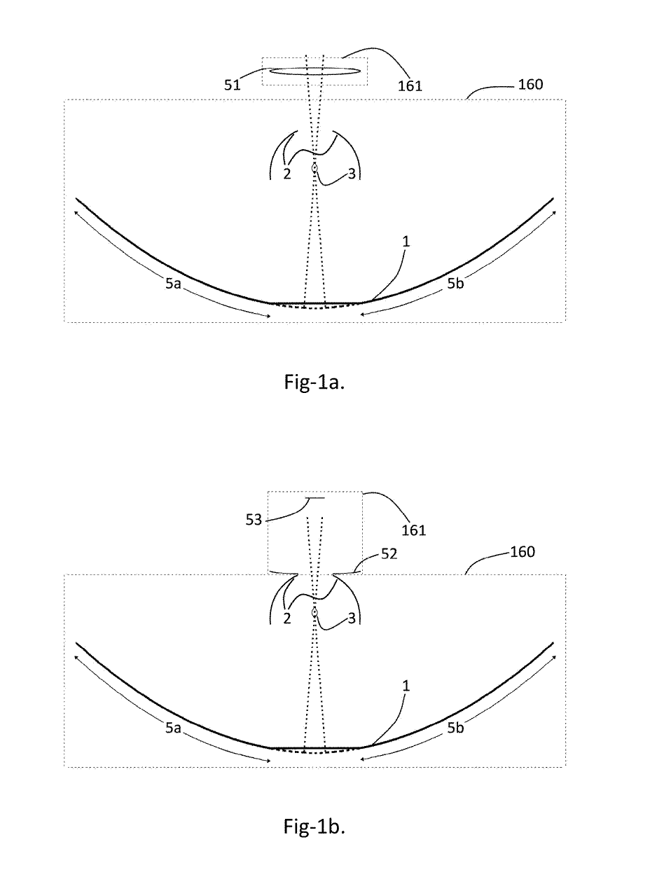

Please refer to FIG. 1a; this embodiment of the invention, a trough type radiation concentrator, includes the main concentrator (160) consisting of a primary reflector (1), a two part secondary reflector (2), a common receiver (3) and a lens (51) as the auxiliary concentrator (161). Please refer to FIG. 1b; this embodiment of the invention, a trough type radiation concentrator, includes the main concentrator (160) consisting of a primary reflector (1), a two part secondary reflector (2), a common receiver (3) and a combination of reflectors (52 and 53) as the auxiliary concentrator (161).

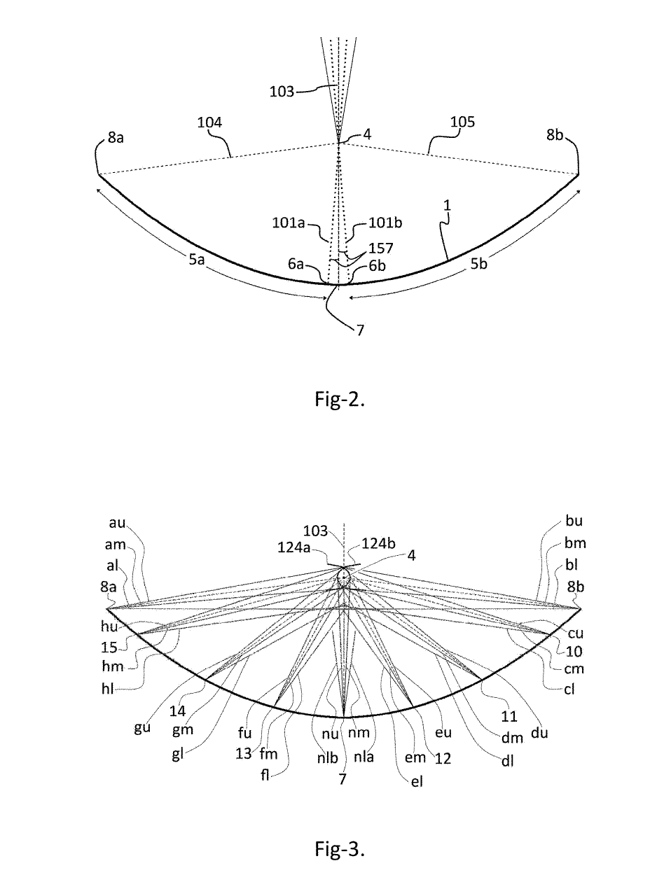

As shown in FIG. 2; the cross section of the primary reflector (1) of the main concentrator consists of two parabolas, the left parabola (5a) and the right parabola (5b), having the same focal length and focal point (4) arranged on either side of the axis of the system (103). While describing the cross sectional view of the primary reflector and the trajectory of light, the left side of the primary reflector will be further referred to as the left parabola (5a) and the right side of the primary reflector will be further referred to as the right parabola (5b) in this document. Also in this document we define the direction of the axis of the system (103) as the vertical direction, the horizontal direction as the direction perpendicular to the vertical direction. Similarly the direction towards the source is considered as the up direction and the opposite direction is considered as the down direction.

The parabolas, the left parabola (5a) and the right parabola (5b), are rotated in opposite directions, keeping the common focus (4) as the center. The rotational angle (157) of the parabolas are defined by the angle formed between the axis (101a) of the left parabola (5a) or the axis (101b) of the right parabola (5b) and the axis of the system (103); which is ¼th the angle subtended by the radiation source. The axis (101a) of the left parabola (5a) and the axis (101b) of the right parabola (5b) pass through or points towards the midpoints of the diagonally opposite halves of the radiation source; when the axis of the system (103) is aligned towards the center of the source. In such an arrangement the left parabola (5a) focuses on the right half of the radiation source and similarly the right parabola (5b) focuses on the left half of the radiation source.

In this exemplary embodiment the left parabola (5a) extends from its apex (6a) towards the axis of the system (103) and the right parabola (5b) extends from its apex (6b) towards the axis of the system (103); and are joined together to form the vertex of the primary reflector (7). The angle formed between the axis of the system (103) and the axis (101a) of the left parabola (5a) and similarly, the angle formed between the axis of the system (103) and the axis (101b) of the right parabola (5b) are termed as the inner rim angles. The inner rim angles are denoted by −θ/2; also the angle subtended by the radiation source is denoted as 2θ. The angle formed between the axis (101a) and the parabolic radius (104), from the left edge (8a), of the left parabola (5a) and similarly, the angle formed between the axis (101b) and the parabolic radius (105), from the right edge (8b), of the right parabola (5b), are termed as the outer rim angles. The outer rim angles can have any value less than 90-20 degrees, which is denoted by ψ_{R}.

The left parabola (5a) and the right parabola (5b) of the primary reflector need not extend towards the vertex when the auxiliary concentrator is used, as the part of the radiation that would have reached the points on the primary reflector near the apexes (6a & 6b) of the parabolas would be directed to the receiver by the auxiliary concentrator (161). The primary reflector of the exemplary embodiment shown in FIG. 2 is described here to illustrate the trajectory of light reflected from it and the curves formed by certain sets of reflected rays, as they form the basis for developing the cross-section of the secondary reflector and receiver for all embodiments of the invention.

Any point on the left parabola (5a) and the right parabola (5b) corresponds to some value for the parameter ψ; which is the angle between the parabolic radius from that point and the axis of the same parabola. And the parameter ψ varies from ψ_{R}, the outer rim angle, to −θ/2, the inner rim angle, of both the left parabola (5a) and the right parabola (5b).

FIG. 3 shows the trajectory of the reflected light, on the cross sectional view of the primary reflector, from the points on the left parabola and the right parabola, corresponding to some arbitrary values of the parameter ψ=ψ_{R}, ψ₃, ψ₂, ψ₁ and −θ/2. Further in this document, we name the points on the left parabola and the right parabola, by the parameter value to which the point corresponds to.

The edge rays from the right side of the source, upon being reflected from points on the left parabola and the edge rays from the left side of the source, upon being reflected from points on the right parabola, passes through points on the axis of the system (103), above the focus (4); and are termed as the upper rays. As shown in FIG. 3; the upper rays from the left parabola include the upper ray (au) from the point ω_{R} (8a), the upper ray (hu) from the point ψ₃ (15), the upper ray (gu) from the point ψ₂ (14) and the upper ray (fu) from the point ψ₁ (13). Similarly, the upper rays from right parabola include the upper ray (bu) from the point ψ_{R} (8b), the upper ray (cu) from the point ψ₃ (10), the upper ray (du) from the point ψ₂ (11), the upper ray (eu) from the point ψ₁ (12).

The rays from the center of the radiation source, upon being reflected from all points on the primary reflector, passes through points on the axis of the system (103), below the focus (4); and are termed as the middle rays. As shown in FIG. 3, the middle rays from the left parabola include the middle ray (am) from the point ψ_{R} (8a), the middle ray (hm) from the point ψ₃ (15), the middle ray (gm) from the point ψ₂ (14) and the middle ray (fm) from the point ψ₁ (13). Similarly, the middle rays from the right parabola include the middle ray (bm) from the point ψ_{R} (8b), the middle ray (cm) from the point ψ₃ (10), the middle ray (dm) from the point ψ₂ (11), the middle ray (em) from the point ψ₁ (12). All the upper rays and the middle rays forms an angle +θ/2 or −θ/2 with the parabolic radius from the points of their reflection.

The edge rays from the left side of the source, upon being reflected from points on the left parabola and the edge rays from the right side of the source, upon being reflected from points on the right parabola, forms an angle θ with the parabolic radius from the points of their reflection and passes through points, on the axis of the system (103), below the focus (4), and are termed as the lower rays. As shown in FIG. 3, the lower rays from the left parabola include the lower ray (al) from the point ψ_{R} (8a), the lower ray (hl) from the point ψ₃ (15), the lower ray (gl) from the point ψ₂ (14) and the lower ray (fl) from the point ψ₁ (13). Similarly, the lower rays from of the right parabola include the lower ray (bl) from the point ψ_{R} (8b), the lower ray (cl) from the point ψ₃ (10), the lower ray (dl) from the point ψ₂ (11) and the lower ray (el) from the point ψ₁ (12).

The edge rays from the right side of the source, upon being reflected from points between the apex of the left parabola and the axis of the system (103) and similarly, the edge rays from the left side of the source, upon being reflected from points, between the apex of the right parabola and the axis of the system (103) do not pass through points on the axis of the system (103); but are still termed as the upper rays in conformity with the nomenclature of the other upper rays. In the same way, the edge rays from the left side and from the center of the source, upon being reflected from the point −θ/2 (7) on the left parabola and the edge rays from the right side and the center of the source, upon being reflected from the point −θ/2 (7) on the right parabola, also do not pass through points on the axis of the system (103); but are still termed as the lower rays and the middle rays respectively; in conformity with the nomenclature of the other lower rays and the middle rays. As shown in FIG. 3, such rays include the upper ray (nu), the middle ray (nm) and the lower ray (nla) from the point −θ/2 (7) of the left parabola and the upper ray (nm), the middle ray (nu) and the lower ray (nlb) from the point −θ/2 (7) of the right parabola. The upper ray (nu) and the middle ray (nm) reflected by the left parabola is same as the middle ray (nu) and the upper ray (nm) reflected by the right parabola, at the vertex of the primary reflector (7).

As shown in FIG. 3, the entire upper rays from the right parabola and the entire middle rays from the left parabola traces out a right caustic curve (124a) engulfing the focus (4) from the right side. Similarly, the entire middle rays from the right parabola and the entire upper rays from the left parabola traces out a left caustic curve (124b) engulfing the focus (4) from the left side.

A method of constructing the right caustic curve (124a) and the left caustic curve (124b) is its approximation by line segments, tangent to the right caustic curve (124a) and the left caustic curve (124b). These tangential line segments are along the entire middle and upper rays from the primary reflector. Every adjacent tangential line segment on the right caustic curve (124a) is along the middle rays from the adjacent points on the left parabola and along the upper rays from the adjacent points on the right parabola. Every adjacent tangential line segment on the left caustic curve (124b) is along the middle rays from the adjacent points on the right parabola and along the upper rays from the adjacent points on the left parabola.

The position of the points of reflection on the right parabola and on the left parabola, relative to the focus and to the axis of the system, can be determined from the parametric equation of parabola rotated through an angle θ/2. The parabolic radius from any point on the right or left parabola, corresponding to a particular value for the parameter ψ, forms an angle ψ+θ/2 with the axis of the system. The trajectory of the upper rays, the middle rays and the lower rays relative to the focus and the axis of the system, can be determined from the position of the points of reflection and the angle formed by them with the corresponding parabolic radius.

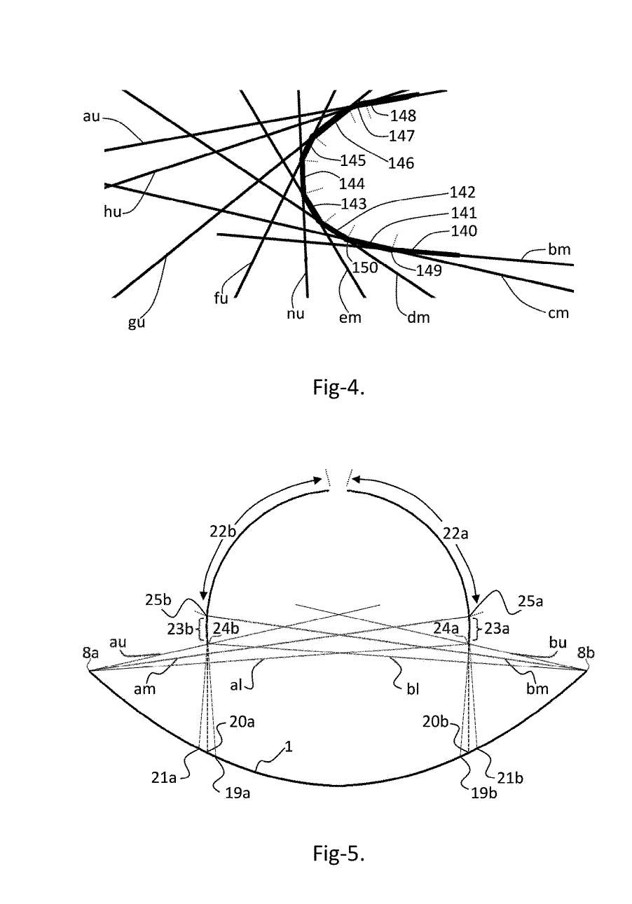

Please refer to FIG. 4, which explains the method of approximating the left caustic curve by nine line segments. The first line segment (140) is along the middle ray (bm) from ψ_{R}, the second line segment (141) is along the middle ray (cm) from ψ₃, the third line segment (142) is along the middle ray (dm) from ψ₂, and the fourth line segment (143) is along the middle ray (em) from ψ₁; where the points represented by the parameter ψ are points on the right parabola. The fifth line segment (144) is along the upper ray (nu) from −θ/2, the sixth line segment (145) is along the upper ray (fu) from ψ₁, the seventh line segment (146) is along the upper ray (gu) from ψ₂, the eighth line segment (147) is along the upper ray (hu) from ψ₃ and the ninth line segment (148) is along the upper ray (au) from ψ_{R}; where the points represented by the parameter ψ and θ/2 are points on the left parabola.

The first end point (149) and the second end point (150), of the second tangential line segment (141) are the points where the middle ray (cm) intersects with the middle ray (bm) from ψ_{R} and the middle ray (dm) ψ₂ on the right parabola respectively. Similarly, the end points of any tangential line segment that is a part of the left caustic curve (124b) are the points of intersection of the ray containing the tangential line segment either with the middle ray or the upper ray, whichever is applicable, from the adjacent points on the primary reflector. The right caustic curve can also be approximated in a similar way. By choosing a closer adjacent point of reflection, more accurate caustic curves can be constructed, as a larger number of smaller line segments tangent to the curves are obtained.

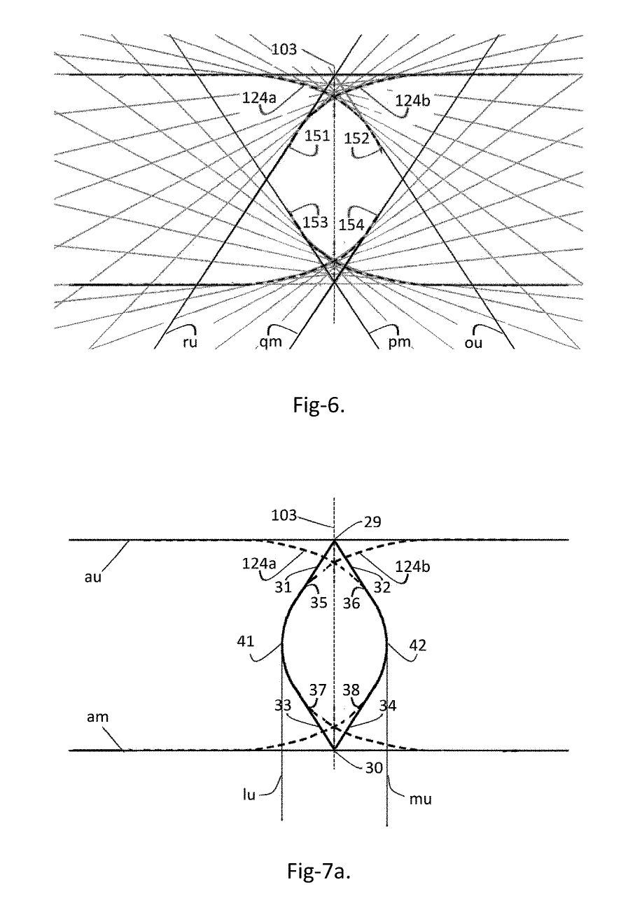

When the auxiliary concentrator (161) is used, the secondary reflector and the auxiliary concentrator blocks a part of the incident radiation, near to its vertex, from reaching the primary reflector both the right and left caustic curves (124a & 124b) will be split into two curves as shown in the FIG. 6. So now consider the size of the secondary reflector in order to understand the change in the shape of the caustic curves.

Please refer to FIG. 5; the lower right edge (24a) of the secondary reflector's cross section is at the point of intersection, between the lower ray (al) from ψ_{R} (8a) of the left parabola and the upper ray (bu) from the ψ_{R} (8b) of the right parabola. Similarly the lower left edge (24b) of the secondary reflector's cross section is at the point of intersection, between the lower ray (bl) from the ψ_{R} (8b) of the right parabola and the upper ray (au) from the ψ_{R} (8a) of the left parabola. The lower left edge (24b) and the lower right edge (24a) of the secondary reflector's cross section defines the aperture of the secondary reflector. A secondary reflector with such an aperture accepts all the rays reflected from the primary reflector (1), with the lowest possible shading of the primary reflector (1). Also there is a gap between the two lines that defines the cross section between the upper right and the upper left edges (22a and 22b) of the secondary.

When the auxiliary concentrator is used; as a result of the shading of the primary reflector there won't be any middle rays or upper rays reflected from the points on the primary reflector below the secondary reflector. The last point of reflection on the left parabola that gives the middle rays is the point (20a) vertically below the lower left edge of the secondary reflector (24b). This point will be further referred to as ψ₈ of the left parabola. Similarly the last point of reflection on the right parabola that gives the middle rays is the point (20b) vertically below the lower right edge of the secondary reflector (24a). This point will be further referred to as ψ₈ of the right parabola. The last point of reflection on the left parabola that gives the upper rays is the point (21a) that intersects with the edge ray from the right side of the source that passes through the lower left edge of the secondary reflector (24b). This point will be further referred to as ψ₉ of the left parabola. Similarly the last point of reflection on the right parabola that gives the upper rays is the point (21b) that intersects with the edge ray from the left side of the source that passes through the lower right edge of the secondary reflector (24a). This point will be further referred to as ψ₉ of the right parabola.

The last point of reflection on the left parabola that gives the lower rays is the point (19a) that intersects with the edge ray from the left side of the source that passes through the lower left edge of the secondary reflector (24b). This point will be further referred to as ψ₇ of the left parabola. Similarly the last point of reflection on the right parabola that gives the lower rays is the point (19b) that intersects with the edge ray from the right side of the source that passes through the lower right edge of the secondary reflector (24a). This point will be further referred to as ψ₇ of the right parabola. As no light will be incident on the primary reflector (1) between the points ψ₇ (19a and 19b) of the left and right parabola (5a and 5b), the left and right parabolas may not extend beyond this points towards the vertex (7).

Please refer to FIG. 6 and FIG. 5; the left caustic curve (124b) breaks between the point (153) of intersection of the middle ray (pm) from the point ψ₈ (20b) on the right parabola (5b) with the left caustic curve (124b) and the point (151) of intersection of the upper ray (ru) from the point ψ₉ (21a) on the left parabola (5a) with the left caustic curve (124b). Similarly, the right caustic curve (124a) breaks between the point (154) of intersection of the middle ray (qm) from the point ψ₈ (20a) on the left parabola (5a) with the right caustic curve (124a) and the point (152) of intersection of the upper ray (ou) from the point ψ₉ (21b) on the right parabola (5b) with the right caustic curve (124a). These points where the caustic curves break are further referred to as the upper left caustic break point (151), the upper right caustic break point (152), the lower left caustic break point (153) and the lower right caustic break point (154).

In the case were the auxiliary concentrator is not used some light will pass through the gap in the secondary reflector vertically above the vertex of the primary, a part of which would further be blocked by the receiver, causing multiple breaks in the caustic curves.

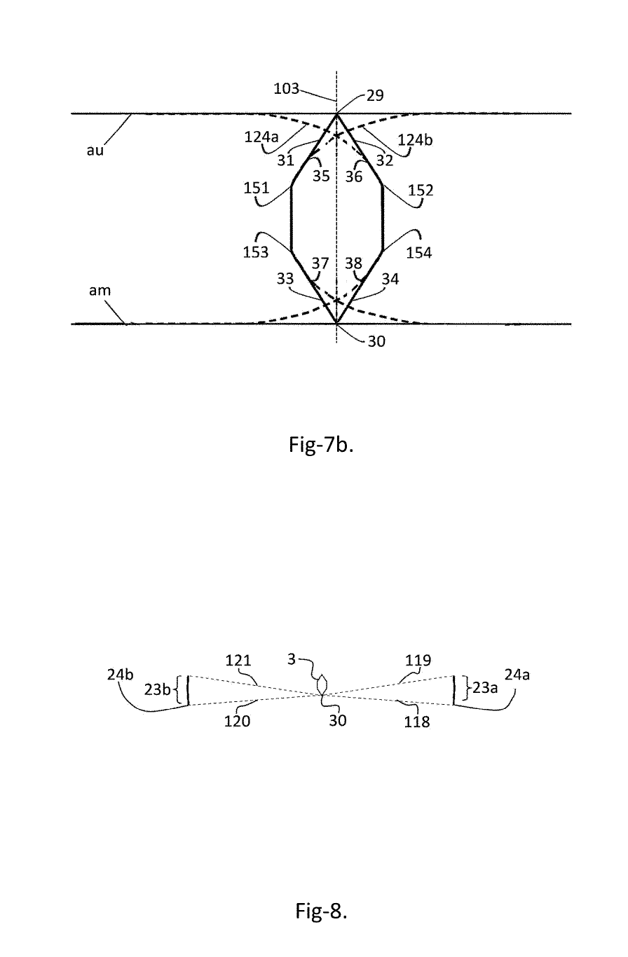

Please refer to FIG. 7a and FIG. 7b; the lower edge (30) of the receiver's (3) cross section is at the intersection of the axis (103) with the middle ray (am) from the point ψ_{R} (8a) of the left uneven parabola (5a). The upper edge (29) of the receiver's (3) cross section is at the intersection of the axis (103) with the upper ray (au) from the point ψ_{R} (8a) of the left uneven parabola (5a). The upper left section (31) of the receiver's (3) cross section is constructed along the tangent to the left caustic curve (124b) from the upper edge (29) of the receiver's (3) cross section to the points of tangency (35). The upper right section (32) of the receiver's (3) cross section is constructed along the tangent to the right caustic curve (124a) from the upper edge (29) of the receiver's (3) cross section to the points of tangency (36). The lower left section (33) of the receiver's (3) cross section is constructed along the tangent to the left caustic curve (124b) from the lower edge (30) of the receiver's (3) cross section to the points of tangency (37). The lower right section (34) of the receiver's (3) cross section is constructed along the tangent to the right caustic curve (124a) from the lower edge (30) of the receiver (3) to the points of tangency (38). From the points of tangency the receiver's (3) cross section is continued along the caustic curves connecting them and wherever the caustic curve breaks due to shading of the primary reflector (1), the receiver's (3) cross section is continued along straight lines connecting the break points of the curve.

In case the auxiliary concentrator (161) is not used, the caustic curves (124a and 124b) are broken by the secondary reflector (2) and the receiver (3), there will be multiple break points in both caustic curves. The surface area of the receiver formed by connecting these multiple break points will not be significantly low compared to the surface area of the receiver formed by the unbroken caustic curves. So in this discussion we use a receiver (3) with the cross section along the unbroken caustic curves (124a and 124b) in case where no auxiliary concentrator is used; as shown in FIG. 7a. In case where an auxiliary concentrator (161) is used; the surface area of the receiver (3) formed by connecting the upper (151 and 152) and lower (153 and 154) break points will be significantly low compared to the surface area of the receiver formed by the unbroken caustic curves. So in this discussion we use a receiver (3) with the cross section along the caustic curve connected by straight lined between the break points in case where auxiliary concentrator (161) is used; as shown in FIG. 7b.

When the auxiliary concentrator (161) is not used, the left most point (41) of the receiver's (3) cross section is along the upper ray (1u) from the apex (6a) of the left uneven parabola (5a) and the right most point (42) of the receiver's (3) cross section is along the upper ray (mu) from the apex (6b) of the right uneven parabola (5b). The width of the receiver's (3) cross section is the distance between the apex (6a) of the left uneven parabola (5a) and the apex (6b) of the right uneven parabola (5b).

Again please refer to FIG. 5; the point of incidence (25a) on the right side of the secondary reflector's cross section by the middle ray (am) from ψ_{R} (8a) of the left uneven parabola, is termed as the right transition point (25a) of the secondary reflector's cross section. Similarly the point of incidence (25b) on the left side of the secondary reflector's cross section by the middle ray (bm) from ψ_{R} (8b) of the right uneven parabola, is termed as the left transition point (25b) of the secondary reflector. The secondary reflector's cross section is divided into lower right section (23a) and lower left section (23b) below the transition points (23a and 23b), and upper right section (22a) and upper left section (22b) above the transition points (23a and 23b). The upper right section (22a) and upper left section (22b) of the secondary reflector joins smoothly with the lower right section (23a) and lower left section (23b) of the secondary reflector at the transition points.

Please refer to FIG. 8, the lower right section (23a) and lower left section (23b) of the secondary reflector's cross section are circular arcs with common center of curvature at the lower edge (30) of the receiver's (3) cross section. The radius of curvature (118 or 119) of the lower right section (23a) and the radius of curvature (120 or 121) of the lower left section (23b) of the secondary reflector has a length equal to the distance between the lower edge (30) of the receiver's (3) cross section and the lower right edge (24a) or the lower left edge (24b) of the secondary reflector's cross section.

The distance between the lower left edge (24b) and the lower right edge (24a) of the secondary reflector was considered as the width of the secondary reflector (2) while calculating the caustic break points. From the FIG. 8, it is clear that the actual width of the secondary reflector is slightly greater than the distance between the lower left edge (24b) and the lower right edge (24b) of the secondary reflector. But as the angle between the lower left radius of curvature (120) and the horizontal line through the lower edge of the receiver (30) is equal to θ, for an embodiment of the invention as a solar collector the actual width of the secondary reflector is only approximately 1.00001 times the value used for calculation and such a small difference can be neglected for most practical purposes.

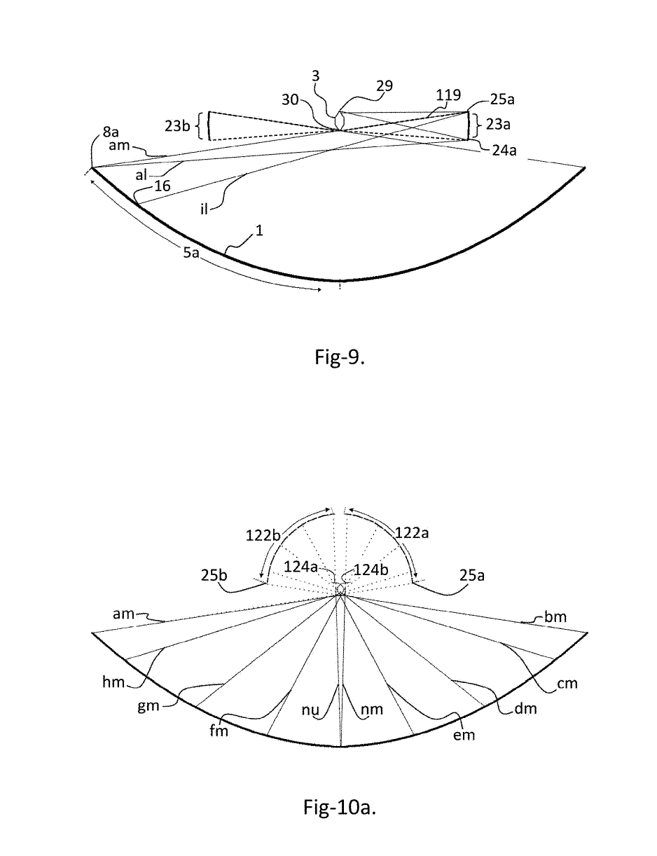

Please refer to FIG. 9; all the rays between the middle ray (am) and the lower ray (al) from the point ψ_{R} (8a) on the left uneven parabola is incident on the lower right section (23a) of the secondary reflector's cross section. As we move through the adjacent points on the primary reflector (1), towards its vertex (7), lesser and lesser rays reflected from the left parabola is incident on the lower right section (23a) of the secondary reflector's cross section. And only the lower ray (il) form the point ψ₄ (16) on the left parabola is incident on the lower right section (23a) of the secondary reflector's cross section. The lower ray (al) from the point ψ_{R} (8a) on the left parabola is reflected to the upper edge (29) of the receiver's (3) cross section. The middle ray (am) from the point ψ_{R} (8a) of the parabola, being collinear to the surface normal (119) of the secondary reflector's cross section at the right transition point (25a), is reflected along the same path as the incident ray; which is tangent to the receiver's (3) cross section. It is implied that the rays between the middle ray (am) and the lower ray (al) from the point ψ_{R} (8a) on the left parabola are also reflected to points on the receiver (3). The lower ray (il) form the point ψ₄ (16) on the left parabola that reaches the right transition point (25a) of the secondary reflector's cross section is also reflected to another point on the receiver's (3) cross section, below its upper edge (29). And it can be concluded that all the rays that reaches the lower right section (23a) and the lower left section (23b) of the secondary reflector's cross section is reflected to the receiver's (3) cross section.

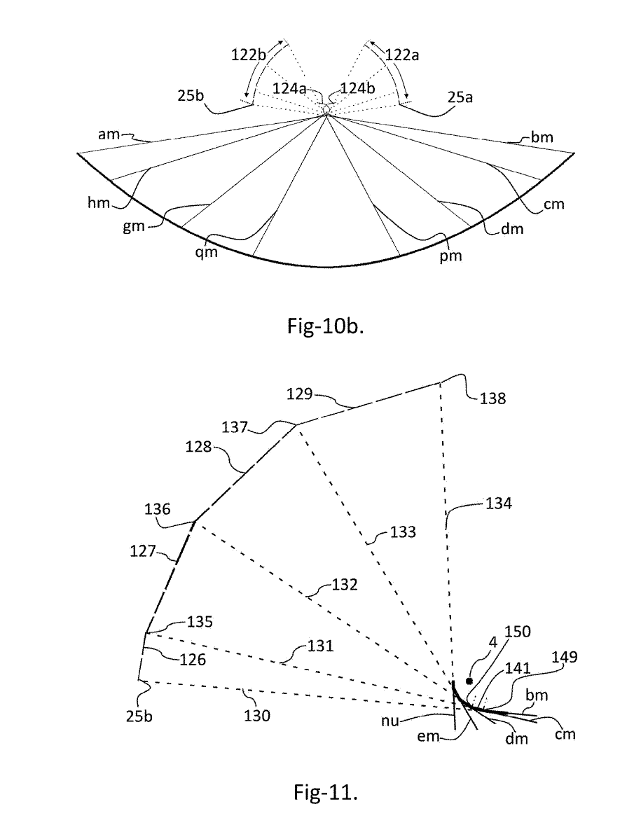

The substantial part of the secondary reflector's (2) cross section is made along two trajectories orthogonal to the middle rays from the left and the right parabola (5a and 5b). Any trajectory orthogonal to the middle rays, with or without the lower section, can be used for the construction of secondary reflectors (2) cross section; however an orthogonal trajectory starting at the said transition points (25a and 25b) combined with the lower section (24a and 24b) gives a simple and efficient secondary reflector. Please refer to FIG. 10a and FIG. 10b; the trajectory on the right side (122a), starting from the right transition point (25a), orthogonal to the extrapolated middle rays (am, hm, gm etc.) from the left parabola and the trajectory on the left side (122b), starting from the left transition point (25b), orthogonal to the extrapolated middle rays (bm, cm, dm etc.) from the right parabola, are the curves that are suitable to be construct the upper right section and the upper left section of the cross section of the secondary reflector respectively. As the entire middle rays from the left parabola are tangents to the right caustic curve (124a) and the entire middle rays from the right parabola are tangents to the left caustic curve (124b), the family of trajectories orthogonal to the extrapolated middle rays on the right and left side are involutes obtained from the right caustic curve (124a) and the left caustic curve (124b), by attaching an imaginary taut string to the caustic curves and tracing their free ends as they are wound onto the caustic curves.

An approximation of the family orthogonal trajectories, including the orthogonal trajectory on the right (122a) and the orthogonal trajectory on the left (122b), may be constructed by the continuum of line segments joining the free ends of an entire set extrapolated middle rays. The term free end of the extrapolated line segment is used in analogy with the free end of the imaginary taut string that traces the involutes.

Please refer to FIG. 11, which explains the method of constructing an approximation of the left orthogonal trajectory. In this example also we make use of the same exemplary approximation of the left caustic curve used in the previous section. Please refer to FIG. 4 also. The first extrapolated line segment (130), which is the extrapolated part of the middle ray (bm) from the point ψ_{R} of the right parabola, starts at the point of its intersection (149) with the middle ray (cm) from the next point, ψ₃ on the right parabola. The free end (25b) of the first extrapolated line segment (130) is at the left transition point (25b) of the secondary reflector's cross section. The second extrapolated line segment (131), which is the extrapolated part of the middle ray (cm) from the point ψ₃ on the right parabola, starts at the point of its intersection (150) with the middle ray (dm) from the next point, ψ₂ on the right parabola. The length of the second extrapolated line segment (131) is obtained by subtracting the length the second tangential line segment (141), that forms the left caustic curve, from the length of the previous extrapolated line segment, i.e. the first extrapolated line segment (130). Similarly the length of every extrapolated line segment, which is the extrapolated part of a middle ray, is obtained by subtracting the length of the tangential line segment along the same middle ray that makes up the approximate caustic curve, from the length of the previous extrapolated line segment.

As the starting point (150), the direction and the length of the second extrapolated line segment (131) can be determined, the free end (135) of the second extrapolated line segment (131) can be located relative to the focus and the axis of the system. Similarly, the free end (136) of the third extrapolated line segment (132), the free end (137) of the fourth extrapolated line segment (133) and the free end (138) of the fifth extrapolated line segment (134) can be located.

An approximation of the left orthogonal trajectory is formed by the continuum of line segments, which are referred to as the orthogonal line segments. The first orthogonal line segment (126) joins the free end (25b) of the first extrapolated line segment (130) and the free end (135) of the second extrapolated line segment (131), the second orthogonal line segment (127) joins the free end (135) of the second extrapolated line segment (131) and the free end (136) of the third extrapolated line segment (132), the third orthogonal line segment (128) joins the free end (136) of the third extrapolated line segment (132) and the free end (137) of the fourth extrapolated line segment (133) and the fourth orthogonal line segment (129) joins the free end (137) of the fourth extrapolated line segment (133) and the free end (138) of the fifth extrapolated line segment (134). The right orthogonal trajectory may also be constructed in a similar way.

By choosing a closer adjacent point of reflection more accurate orthogonal trajectories can be constructed, as a larger number of smaller orthogonal line segments joining a larger number of free ends of the extrapolated middle rays are obtained.

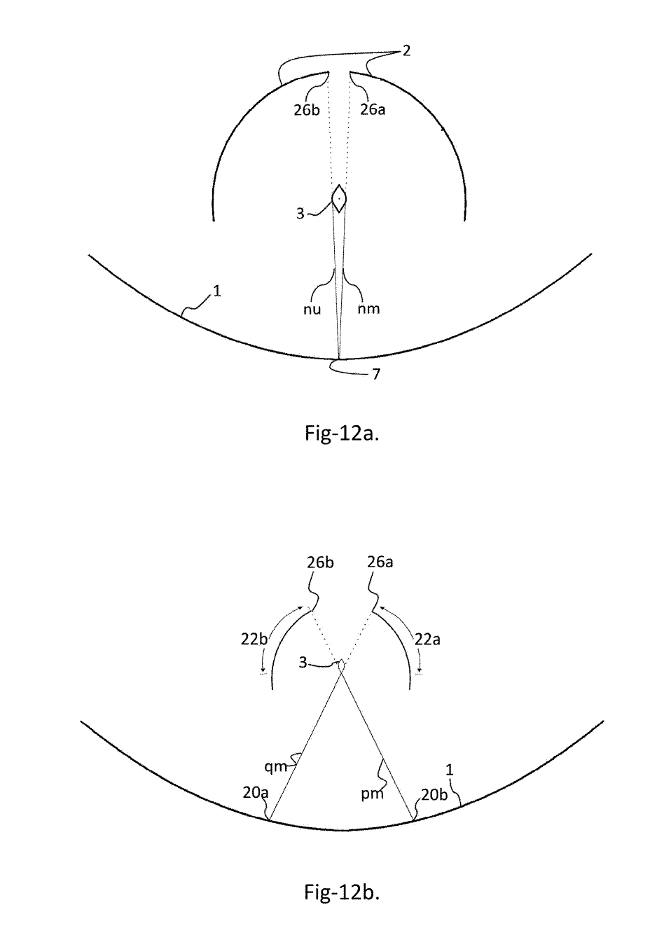

Please refer to FIG. 12a; when auxiliary concentrator is not used, as there is a discontinuity in the direction of the middle rays when we move from one side of the axis (103) to the other side, the secondary reflector (2) has an opening between the upper right edge (26a) and the upper left edge (26b) above the receiver (3) through which some light from the source reaches the receiver (3) directly.

Please refer to FIG. 12b; as no middle ray is reflected from the primary reflector (1) from points ψ₈ (20a and 20b) on the left and right parabola (5a and 5b) the orthogonal trajectories that make up the cross section of the secondary reflector (2) terminate at the upper right edge (26a) and the upper left edge (26b) of the secondary reflector (2). And hence, the secondary reflector (2) has a larger opening, when auxiliary concentrator (161) is used, between the upper right edge (26a) and the upper left edge (26b), directly above the receiver (3), through which the auxiliary concentrator can concentrate radiation to the receiver (3).

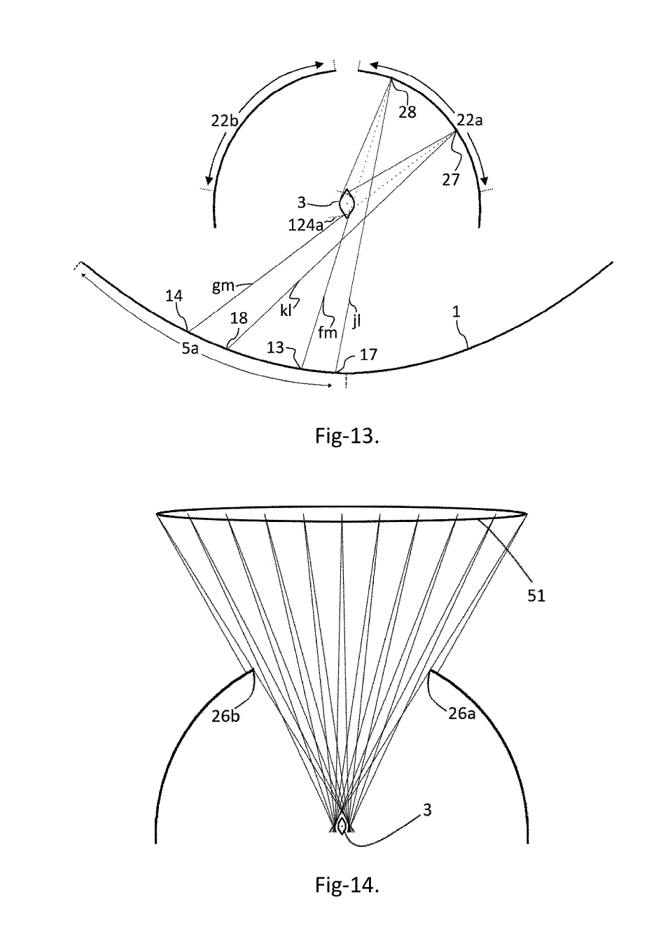

Please refer to FIG. 13, the normal to the upper right section (22a) of the secondary reflector's cross section at the point (28) where the lower ray (jl) from the point ψ₅ (17) of the left parabola (5a) is incident and the normal to the upper right section (22a) of the secondary reflector's cross section at the point (27) where the lower ray (kl) from the point ψ₆ (18) of the left parabola (5a) is incident, are collinear to the middle ray (fm) form the point ψ₁ (13) and to the middle ray (gm) form the point ψ₂ (14) from the left parabola (5a) respectively. The lower ray (jl) from the point ψ₅ (17) and the lower ray (kl) from the point ψ₆ (18) on the left parabola (5a) are reflected on to the receiver (3). All the middle rays from the left parabola (5a), being collinear to the surface normals to the upper right section (22a) of the secondary reflector's cross section are reflected back along the same trajectory, which is tangent to the right caustic (124a) and are incident on the receiver (3). And it can be concluded that all the rays from the middle ray through the lower ray, from all points on the primary reflector (1) that reaches the upper right section (22a) and the upper left section (22b) of the secondary reflector's (2) cross section, are reflected to the receiver (3).

An embodiment of the invention uses a lens (51) of the same size as the secondary reflector (2) of the as the auxiliary concentrator (161), positioned above the secondary reflector (2) in such a way that its focus is at the common focus (4) or in close proximity to the common focus (4) of the parabolas (5a and 5b) of the primary reflector; as shown in FIG. 1a. The lens concentrates the radiation that was supposed to be blocked by the secondary reflector (2) along with the radiation that would pass through the gap between the two sides of the secondary reflector to the receiver (3).

Another embodiment of the invention uses a combination of concave (parabolic, cylindrical, modified parabolic etc.) first reflector (52) and matching second reflector (53) as the auxiliary concentrator (161), in which the first reflector (52) has an aperture of the same size as the secondary reflector (2), positioned above the secondary reflector (2), in such a way that its focus is at the common focus (4) or in close proximity to the common focus (4) of the parabolas (5a and 5b) of the primary reflector; as shown in FIG. 1b. The auxiliary concentrator (161) concentrates the radiation that was supposed to be blocked by the secondary reflector (2) along with the radiation that would pass through the gap between the two sides of the secondary reflector to the receiver (3). But the second reflector (53) of the auxiliary concentrator (161) still blocks some radiation from reaching the receiver (3).

The auxiliary concentrator (161) can be any combination of refractive elements like multiple lenses, where all the lenses arranged with their axes collinear to the axes of the system (103), or where different lenses are configured to focus different parts of the radiation that would have been blocked by the secondary reflector (2) to same or different points in proximity to the receiver (3). Combinations of lenses and mirrors can also function as a good auxiliary concentrator (161).

### Best Method of Performing the Invention as a Solar Collector

Different embodiments of the invention, for a particular radiation source subtending an angle 2θ, having primary reflector of different outer rim angle values, have the secondary reflectors and the receivers of different relative sizes. Once the cross section of the concentrator according to this invention is constructed, for a particular outer rim angle and for a particular source, the concentrator can be easily made as a trough type concentrator or a dish type concentrator. These different embodiments also have different concentration ratios and there exists at least one embodiment, for both trough type and dish type, which has the maximum concentration for each radiation source that subtends a different angle, 2θ.

The embodiment of the invention, as a trough type solar collector, has a very small cross section for the secondary reflector (2) and the receiver tube (3) relative to the primary reflector, owing to the fact that the angle subtended by the Sun (2θ) is approximately 0.52°. To find the embodiment that has the maximum concentration ratio, various embodiments of the invention were studied numerically. The various embodiments included the trough type solar collectors, with and without the auxiliary concentrator, with primary reflectors (1) of different outer rim angles and matching secondary reflector (2) and receiver (3). The auxiliary concentrator (161) used in the study was a simple convex lens having the same area as the secondary reflector (2) with different focal lengths placed at different distances from the focus (4) of the primary reflector (1) in such a way that the focus of the lens varied from the lower most point of the receivers cross section (30) to the upper most point of the receivers cross section (29).

The ratio of reduced surface area of the aperture, due to the shading of the primary reflector (1) by the secondary reflector (2), to the surface area of the receiver (3) is termed as the effective concentration ratio. The optimum effective concentration ratio for the trough type solar collector, without the auxiliary concentrator, is achieved when the outer rim angle is approximately 84° and the achieved effective concentration ratio is approximately 178.47; which is approximately 80.99% of the ideal concentration.

The ratio of reduced surface area of the aperture, due to the shading of the primary reflector (1) by the secondary reflector (2), plus the percentage of light from the auxiliary concentrator (161) absorbed by the receiver (3) multiplied by the area of the secondary reflector (2), to the surface area of the receiver (3) is termed as the final concentration ratio. The optimum final concentration ratio for the trough type solar collector, with a convex lens as the auxiliary concentrator, is achieved when the outer rim angle is approximately 85° and when the focal length of the lens is 71.31% of the focal length of the left and right parabolas (5a & 5b) and it concentrates to a point in the axis within the cross section of the receiver. The achieved final concentration ratio is approximately 184.36; which is approximately 83.67% of the ideal concentration.

### LIST OF REFERENCE SYMBOLS

1 Primary Reflector
2 Secondary Reflector
3 Receiver
4 Focus
5a Left parabola
5b Right parabola
6a Apex of the left parabola
6b Apex of the right parabola
7 Vertex of the primary reflector/A point on the left or right parabola corresponding to the value for the parameter ψ=−θ/2
8a A point on the left parabola corresponding to the value for the parameter ψ=ψ_{R}
8b A point on the right parabola corresponding to the value for the parameter ψ=ψ_{R}
10 A point on the right parabola corresponding to the value for the parameter ψ=ψ₃
11 A point on the right parabola corresponding to the value for the parameter ψ=ψ₂
12 A point on the right parabola corresponding to the value for the parameter ψ=ψ₁
13 A point on the left parabola corresponding to the value for the parameter ψ=ψ₁
14 A point on the left parabola corresponding to the value for the parameter ψ=ψ₂
15 A point on the left parabola corresponding to the value for the parameter ψ=ψ₃
16 A point on the left parabola corresponding to the value for the parameter ψ=ψ₄
17 A point on the left parabola corresponding to the value for the parameter ψt=ψ₅
18 A point on the left parabola corresponding to the value for the parameter ψ=ψ₆
19a A point on the left parabola corresponding to the value for the parameter ψ=ψ₇
19b A point on the right parabola corresponding to the value for the parameter ψ=ψ₇
20a A point on the left parabola corresponding to the value for the parameter ψ=ψ₈
20b A point on the right parabola corresponding to the value for the parameter ψ=ψ₈
21a A point on the left parabola corresponding to the value for the parameter ψ=ψ₉
21b A point on the right parabola corresponding to the value for the parameter ψ=ψ₉
22a Upper right section of secondary reflector
22b Upper left section of secondary reflector
23a Lower right section of secondary reflector
23b Lower left section of secondary reflector
24a Lower right edge of secondary reflector
24b Lower left edge of secondary reflector
25a Right transition point of secondary reflector
25b Left transition point of secondary reflector/free end of the first extrapolated line segment
26a Upper right edge of secondary reflector
26b Upper left edge of secondary reflector
27 A point on the upper right section of secondary reflector
28 A point on the upper right section of secondary reflector
29 Upper edge of the receiver
30 Lower edge of the receiver
31 Upper left section of the receiver
32 Upper right section of the receiver
33 Lower left section of the receiver
34 Lower right section of the receiver
35 Upper left tangent point on the receiver
36 Upper right tangent point on the receiver
37 Lower left tangent point on the receiver
38 Lower right tangent point on the receiver
41 Left most point of the receiver
42 Right most point of the receiver
51 Lens (Auxiliary)
52 First Reflector (Auxiliary)
53 Second Reflector (Auxiliary)
101a Axis of left parabola
101b Axis of right parabola
103 Axis of the system
104 Parabolic radius of the left parabola towards the point on its left edge
105 Parabolic radius of the right parabola towards the point on its right edge
118 A radial line of the lower right section of the secondary reflector
119 A radial line of the lower right section of the secondary reflector
120 A radial line of the lower left section of the secondary reflector
121 A radial line of the lower left section of the secondary reflector
122a Right orthogonal trajectory
122b Left orthogonal trajectory
124a Right caustic curve
124b Left caustic curve
130 First extrapolated line segment
131 Second extrapolated line segment
132 Third extrapolated line segment
133 Fourth extrapolated line segment
134 Fifth extrapolated line segment
135 Free end of the second extrapolated line segment
136 Free end of the third extrapolated line segment
137 Free end of the fourth extrapolated line segment
138 Free end of the fifth extrapolated line segment
140 First line segment of the exemplary left caustic curve
141 Second line segment of the exemplary left caustic curve
142 Third line segment of the exemplary left caustic curve
143 Fourth line segment of the exemplary left caustic curve
144 Fifth line segment of the exemplary left caustic curve
145 Sixth line segment of the exemplary left caustic curve
146 Seventh line segment of the exemplary left caustic curve
147 Eighth line segment of the exemplary left caustic curve
148 Ninth line segment of the exemplary left caustic curve
149 First end point of the second line segment of the exemplary left caustic curve
150 Second end point of the second line segment of the exemplary left caustic curve
151 Upper left caustic break point
152 Upper right caustic break point
153 Lower left caustic break point
154 Lower right caustic break point
157 Rotational angle of the parabolas
nu The trajectory of the upper ray from a point on the left parabola corresponding to the value for the parameter ψ=−θ/2/The trajectory of the middle ray from a point on the right parabola corresponding to the value for the parameter ψ=−θ/2
nm The trajectory of the middle ray from a point on the left parabola corresponding to the value for the parameter ψ=−θ/2/The trajectory of the upper ray from a point on the right parabola corresponding to the value for the parameter ψ=−θ/2
nla The trajectory of lower ray from the point on the left parabola corresponding to the value for the parameter ψ=−θ/2
nlb The trajectory of lower ray from the point on the right parabola corresponding to the value for the parameter ψ=−θ/2

The trajectory of light reflected from every other point of the primary reflector is referenced by a two letter symbol. The first letter of the two letter symbol represents the following:
a The trajectory of light from a point on the left parabola corresponding to the value for the parameter ψ=ψ_{R}
b The trajectory of light from a point on the right parabola corresponding to the value for the parameter ψ=ψ_{R}
c The trajectory of light from a point on the right parabola corresponding to the value for the parameter ψ=ψ₃
d The trajectory of light from a point on the right parabola corresponding to the value for the parameter ψ=ψ₂
e The trajectory of light from a point on the right parabola corresponding to the value for the parameter ψ=ψ₁
f The trajectory of light from a point on the left parabola corresponding to the value for the parameter ψ=ψ₁
g The trajectory of light from a point on the left parabola corresponding to the value for the parameter ψ=ψ₂
h The trajectory of light from a point on the left parabola corresponding to the value for the parameter ψ=ψ₃
i The trajectory of light from a point on the left parabola corresponding to the value for the parameter ψ=ψ₄
j The trajectory of light from a point on the left parabola corresponding to the value for the parameter ψ=ψ₅
k The trajectory of light from a point on the left parabola corresponding to the value for the parameter ψ=ψ₆
l The trajectory of light from the apex of the left parabola
m The trajectory of light from the apex of the right parabola
o The trajectory of light from a point on the right parabola corresponding to the value for the parameter ψ=ψ₉
p The trajectory of light from a point on the right parabola corresponding to the value for the parameter ψ=ψ₈
q The trajectory of light from a point on the left parabola corresponding to the value for the parameter ψ=ψ₈
r The trajectory of light from a point on the left parabola corresponding to the value for the parameter ψ=ψ₉

The second letter of the two letter symbol represents the following:
u Upper ray of the light
m Middle ray of the light
l Lower ray of the light

I claim:

1- A radiation concentrator comprising of:
a primary reflector, for which the cross section approximates sections/parts of a pair of parabolas arranged on either side of the axis of the system, said parabolas having a common focus on the axis of the system, said parabolas being rotated in opposite directions relative to the axis of the system through rotational angles defined by the angles between the axes of said parabolas and the axis of the system;
a receiver placed at the common focus of said parabolas, in such a way that it directly absorbs a part of the radiation reflected from all points on the primary reflector; and
a secondary reflector, for which the cross section is given by a pair of concave curves, arranged on either side of the axis of the system, facing the diagonally opposite parabola of the primary reflector.

2- A radiation concentrator as said in claim 1, wherein the rotational angle of said parabolas is ¼^{th} the angle subtended by the radiation source.

3- A radiation concentrator as said in claim 2, wherein the upper and lower edges of the receiver's cross section lie on the axis of the system, at the point of intersection with the upper ray and middle ray, from the outer edge of the primary reflector.

4- A radiation concentrator as said in claim 3, wherein the receiver's cross section lie between the trajectory of the upper rays from the apexes of said parabolas of the primary reflector, on either side of the axis of the system.

5- A radiation concentrator as said in claim 4, wherein the curve that forms the receiver's cross section extends from the upper and lower edges, along line segments tangent to the caustic curves, formed by the upper rays and the middle rays from the primary reflector, till the point of tangency and continued along said caustic curves and connected by straight lines where the caustic curves break due to shading.

6- A radiation concentrator as said in claim 5, wherein the lower end of both curves that forms the cross section of secondary reflector is at the intersection of the upper ray, from outer edge of said parabolas of the primary reflector on same side of the axis of the system as the curve of the secondary reflector, with the lower ray, from outer edge of said parabolas of the primary reflector on the other side of the axis of the system.

7- A radiation concentrator as said in claim 6, wherein the substantial section of both curves that forms the cross section of secondary reflector are trajectories orthogonal to the middle rays, from said parabolas of the primary reflector on the either side of the axis.

8- A radiation concentrator as said in claim 7, wherein the lower sections of both curves that form the cross section of secondary reflector are circular arcs, for which the center of curvature is at the lower edge of the receiver.

9- A radiation concentrator as said in claim-7, wherein an auxiliary concentrator is placed above the opening in the secondary reflector, configured to direct a substantial part of the radiation that would have been blocked by the secondary reflector to the receiver.

10- A radiation concentrator as said in claim-9, wherein the auxiliary concentrator is one or more refractive and/or elements functioning either independently or in connection with each other configured to focus radiation through the opening in the secondary reflector to one or more points within or in the vicinity of the receiver.
